(19) United States
(12) Patent Application Publication
(10) Pub. No.: US 2026/0183846 A1
(43) Pub. Date: Jul. 2, 2026

(54) CUTTING TOOL

(71) Applicant: SUMITOMO ELECTRIC HARDMETAL CORP., Itami-shi, Hyogo (JP)

(72) Inventors: Masahito HIKIJI, Itami-shi, Hyogo (JP); Takato YAMANISHI, Itami-shi, Hyogo (JP); Atsuhiro YONEDA, Itami-shi, Hyogo (JP)

(73) Assignee: SUMITOMO ELECTRIC HARDMETAL CORP., Itami-shi, Hyogo (JP)

(21) Appl. No.: 19/125,769

(22) PCT Filed: Jul. 24, 2024
(86) PCT No.: PCT/JP2024/026444

§ 371 Date: Apr. 30, 2025

(51) Int. Cl. B23B 27/14

(52) U.S. Cl. CPC B23B 27/148; B23B 2224/04; B23B 2224/32; B23B 2228/105; B23B 2228/36

(57) ABSTRACT

A cutting tool comprising a substrate and a coating on the substrate,
the coating including
   an alumina layer on the substrate,
   an intermediate layer directly on the alumina layer, and
   a titanium carbonitride layer directly on the intermediate layer,
the titanium carbonitride layer being made of TiₓC_{y}N_{(1-y)},
at a point A of titanium carbonitride layer,
   the titanium carbonitride layer having atomic ratio x_{A} of 1.3 to 1.6 for titanium, and atomic ratio y_{A} of 0.4 to 0.6 for carbon,
at a point B of titanium carbonitride layer,
   the titanium carbonitride layer having atomic ratio x_{B} of 0.8 to 1.2 for titanium and atomic ratio y_{B} of 0.3 to 0.5 for carbon,
at a point C of titanium carbonitride layer,
   the titanium carbonitride layer having atomic ratio x_{C} larger than x_{B} and less than x_{A} for titanium, and atomic ratio y_{C} larger than y_{B} and less than y_{A} for carbon.

### TECHNICAL FIELD

The present disclosure relates to a cutting tool.

### BACKGROUND ART

A conventionally used cutting tool comprises a substrate and a coating provided thereon. For example, Japanese National Patent Publication No. 2020-516469 (PTL 1) discloses a coated cutting tool comprising a substrate coated with a multi-layered wear resistant coating comprising a layer of α-Al₂O₃ and a layer of titanium carbonitride TiₓC_{y}N_{1-y}, with 0.85≤x≤1.3, preferably 1.1≤x≤1.3 and 0.4≤y≤0.85, deposited on the α-Al₂O₃ layer, wherein the TiₓC_{y}N_{1-y} exhibits a texture coefficient TC(hkl), as measured by X-ray diffraction using CuKα radiation and θ-2θ scan, the TC(hkl) being defined according to Harris formula, wherein the (hkl) reflections used are (1 1 1), (2 0 0), (2 2 0), (3 1 1), (3 3 1), (4 2 0) and (4 2 2) and wherein TC (1 1 1)≥3.

WO2021/193676 (PTL 2) discloses a coated tool comprising a base and a coating layer located on the base, the coated tool comprising a first surface, a second surface adjacent to the first surface, and a cutting edge located on at least a part of a ridge part of the first and second surfaces, wherein the coating layer comprises a first coating layer comprising a first layer comprising Al₂O₃ particles, and a second layer located on the first layer, the second layer comprises, sequentially from a side of the base, a first film, a second film in contact with the first film, and a third film in contact with the second film, the first, second and third films individually comprise Ti, the first, second and third films individually comprise at least one kind selected from C and N, the coated tool satisfies a relationship of a first N content>a third N content>a second N content, in which the first N content is an N content in the first film, the second N content is an N content in the second film, and the third N content is an N content in the third film.

### CITATION LIST

### Patent Literature

PTL 1: Japanese National Patent Publication No. 2020-516469

PTL 2: WO 2021/193676

### SUMMARY OF INVENTION

The presently disclosed cutting tool is
a cutting tool comprising a substrate and a coating provided on the substrate,
the coating including
   an alumina layer provided on the substrate,
   an intermediate layer provided directly on the alumina layer, and
   a titanium carbonitride layer provided directly on the intermediate layer,
the intermediate layer being made of titanium oxycarbonitride,
the titanium carbonitride layer being made of a compound represented by TiₓC_{y}N_{(1-y)},
at a point A 0.2 μm away from an interface I between the intermediate layer and the titanium carbonitride layer in a depthwise direction toward the titanium carbonitride layer,
   the titanium carbonitride layer having an atomic ratio x_{A} of 1.3 or more and 1.6 or less for titanium,
   the titanium carbonitride layer having an atomic ratio y_{A} of 0.4 or more and 0.6 or less for carbon,
at a point B 1.0 μm away from an interface J at the titanium carbonitride layer opposite to interface I in the depthwise direction toward the titanium carbonitride layer,
   the titanium carbonitride layer having an atomic ratio x_{B} of 0.8 or more and 1.2 or less for titanium,
   the titanium carbonitride layer having an atomic ratio y_{B} of 0.3 or more and 0.5 or less for carbon,
at a point C that is a midpoint between points A and B,
   the titanium carbonitride layer having an atomic ratio x_{C} larger than the atomic ratio x_{B} and less than the atomic ratio x_{A} for titanium,
   the titanium carbonitride layer having an atomic ratio y_{C} larger than the atomic ratio y_{B} and less than the atomic ratio y_{A} for carbon,
the intermediate layer having a thickness of 0.5 μm or more and 1.5 μm or less,
the titanium carbonitride layer having a thickness of 1.5 μm or more and 3.5 μm or less.

### BRIEF DESCRIPTION OF DRAWINGS

FIG. 1 is a perspective view for illustrating a substrate of a cutting tool in one manner.

FIG. 2 is a schematic cross section of a cutting tool according to one embodiment in one manner.

FIG. 3 is a schematic cross section of a cutting tool according to the present embodiment in another manner.

FIG. 4 is a schematic cross section of a coating layer according to the present embodiment in one manner.

FIG. 5 is a schematic cross section showing an example of a chemical vapor deposition apparatus used for producing a coating.

### DETAILED DESCRIPTION

### Problem to be Solved by the Present Disclosure

The cutting tools disclosed in PTLs 1 and 2, having a coating configured as described above, are enhanced in wear resistance and hence expected to have an increased lifetime. Furthermore, the cutting tool disclosed in PTL 2 is also enhanced in welding resistance as well as wear resistance.

However, faster and more efficient cutting processes in recent years tend to impose increased loads on cutting tools and reduce their lifetimes. Accordingly, there is a demand for a cutting tool having a coating with further improved mechanical properties (e.g., wear resistance, peeling resistance and breaking resistance).

The present disclosure has been made in view of the above circumstances, and an object thereof is to provide a cutting tool excellent in wear resistance and peeling resistance.

### Advantageous Effect of the Present Disclosure

According to the present disclosure, a cutting tool excellent in wear resistance and peeling resistance can be provided.

### DESCRIPTION OF EMBODIMENTS OF THE PRESENT DISCLOSURE

Initially, embodiments of the present disclosure will be listed and specifically described.

[1] The presently disclosed cutting tool is
a cutting tool comprising a substrate and a coating provided on the substrate,
the coating including
   an alumina layer provided on the substrate,
   an intermediate layer provided directly on the alumina layer, and
   a titanium carbonitride layer provided directly on the intermediate layer,
the intermediate layer being made of titanium oxycarbonitride,
the titanium carbonitride layer being made of a compound represented by TiₓC_{y}N_{(1-y)},
at a point A 0.2 μm away from an interface I between the intermediate layer and the titanium carbonitride layer in a depthwise direction toward the titanium carbonitride layer,
   the titanium carbonitride layer having an atomic ratio x_{A} of 1.3 or more and 1.6 or less for titanium,
   the titanium carbonitride layer having an atomic ratio y_{A} of 0.4 or more and 0.6 or less for carbon,
at a point B 1.0 μm away from an interface J at the titanium carbonitride layer opposite to interface I in the depthwise direction toward the titanium carbonitride layer,
   the titanium carbonitride layer having an atomic ratio x_{B} of 0.8 or more and 1.2 or less for titanium,
   the titanium carbonitride layer having an atomic ratio y_{B} of 0.3 or more and 0.5 or less for carbon,
at a point C that is a midpoint between points A and B,
   the titanium carbonitride layer having an atomic ratio x_{C} larger than the atomic ratio x_{B} and less than the atomic ratio x_{A} for titanium,
   the titanium carbonitride layer having an atomic ratio y_{C} larger than the atomic ratio y_{B} and less than the atomic ratio y_{A} for carbon,
the intermediate layer having a thickness of 0.5 μm or more and 1.5 μm or less,
the titanium carbonitride layer having a thickness of 1.5 μm or more and 3.5 μm or less.

The above cutting tool thus configured is excellent in wear resistance and peeling resistance. As used herein, “wear resistance” means resistance against wearing of the coating when the cutting tool is used in a cutting process. “Peeling resistance” means resistance against peeling of the titanium carbonitride layer off the intermediate layer when the cutting tool is used in a cutting process. The peeling resistance can also be expressed as “adhesiveness”.

Conventionally, a titanium oxycarbonitride layer has been formed on a titanium carbonitride layer. In that case, needle crystals of titanium oxycarbonitride are formed on the titanium carbonitride layer (columnar crystals). Therefore, the two layers are improved in peeling resistance by an anchor effect of the needle crystal. However, an aspect in which the titanium carbonitride layer and the titanium oxycarbonitride layer are deposited in layers in the opposite order and the two layers are improved in peeling resistance has not been known. As a result of a diligent study, the present inventors have first found that when a titanium carbonitride layer is formed on a titanium oxycarbonitride layer (or an intermediate layer), increasing an atomic ratio of titanium in the titanium carbonitride layer at a location closer to the intermediate layer helps carbon and nitrogen constituting the intermediate layer to diffuse into the titanium carbonitride layer, and enhances the two layers' peeling resistance while keeping the titanium carbonitride layer's wear resistance.

[2] The alumina layer may have a thickness of 2 μm or more and 20 μm or less. Such a definition allows the cutting tool to be further excellent in wear resistance.

[3] At the point A,
the titanium carbonitride layer may have an atomic ratio x_{A} of 1.4 or more and 1.5 or less for titanium, and
the titanium carbonitride layer may have an atomic ratio y_{A} of 0.45 or more and 0.55 or less for carbon. Such a definition allows the cutting tool to be further excellent in peeling resistance.

[4] At the point B,
the titanium carbonitride layer may have an atomic ratio x_{B} of 0.8 or more and 1.1 or less for titanium, and
the titanium carbonitride layer may have an atomic ratio y_{B} of 0.3 or more and 0.45 or less for carbon. Such a definition allows the cutting tool to be further excellent in wear resistance.

[5] The coating may have a thickness of 6 μm or more and 30 μm or less. Such a definition allows the cutting tool to be further excellent in wear resistance.

[6] The coating may further include an underlying layer provided between the substrate and the alumina layer. Such a definition allows the cutting tool to be further excellent in wear resistance.

[7] The coating may further include a surface layer provided on the titanium carbonitride layer. Such a definition allows the cutting tool to be excellent in visibility for a used cutting edge.

### DETAILED DESCRIPTION OF EMBODIMENTS

Hereinafter, an embodiment of the present disclosure (hereinafter also referred to as “the present embodiment”) will be described. It should be noted, however, that the present embodiment is not exclusive. In the present specification, an expression in the form of “X to Z” means upper and lower limits for a range (that is, X or more and Z or less), and when X is not accompanied by any unit and Z is alone accompanied by a unit, X has the same unit as Z. Further, in the present specification, when a compound is represented by a chemical formula with its constituent elements' composition ratio unspecified, such as “TiC,” the chemical formula shall encompass any conventionally known composition ratio (or elemental ratio). The chemical formula shall include not only a stoichiometric composition but also a nonstoichiometric composition. For example, the chemical formula of “TiC” includes not only a stoichiometric composition of “Ti₁C₁” but also a non-stoichiometric composition for example of “Ti₁C_{0.8}.” This also applies to compounds other than “TiC.”

### <<Cutting Tool>>

The presently disclosed cutting tool is
a cutting tool comprising a substrate and a coating provided on the substrate,
the coating including
   an alumina layer provided on the substrate,
   an intermediate layer provided directly on the alumina layer, and
   a titanium carbonitride layer provided directly on the intermediate layer,
the intermediate layer being made of titanium oxycarbonitride,
the titanium carbonitride layer being made of a compound represented by TiₓC_{y}N_{(1-y)},
at a point A 0.2 μm away from an interface I between the intermediate layer and the titanium carbonitride layer in a depthwise direction toward the titanium carbonitride layer,
   the titanium carbonitride layer having an atomic ratio x_{A} of 1.3 or more and 1.6 or less for titanium,
   the titanium carbonitride layer having an atomic ratio y_{A} of 0.4 or more and 0.6 or less for carbon,
at a point B 1.0 μm away from an interface J at the titanium carbonitride layer opposite to interface I in the depthwise direction toward the titanium carbonitride layer,
   the titanium carbonitride layer having an atomic ratio x_{B} of 0.8 or more and 1.2 or less for titanium,
   the titanium carbonitride layer having an atomic ratio y_{B} of 0.3 or more and 0.5 or less for carbon,
at a point C that is a midpoint between points A and B,
   the titanium carbonitride layer having an atomic ratio x_{C} larger than the atomic ratio x_{B} and less than the atomic ratio x_{A} for titanium,
   the titanium carbonitride layer having an atomic ratio y_{C} larger than the atomic ratio y_{B} and less than the atomic ratio y_{A} for carbon,
the intermediate layer having a thickness of 0.5 μm or more and 1.5 μm or less,
the titanium carbonitride layer having a thickness of 1.5 μm or more and 3.5 μm or less.

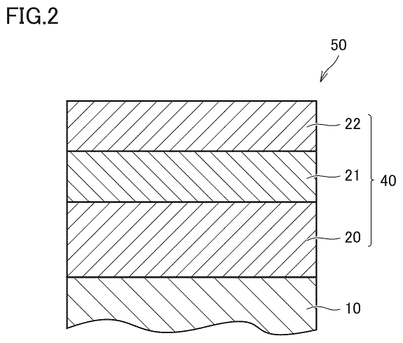

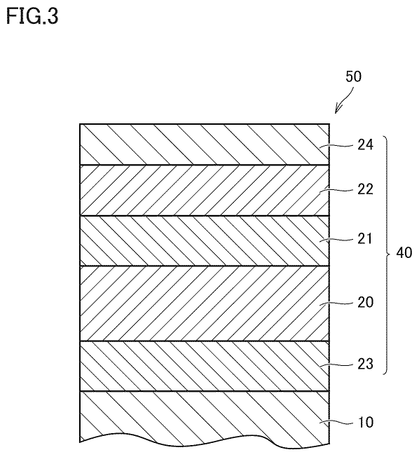

According to the present embodiment, a cutting tool 50 comprises a substrate 10 and a coating 40 provided on substrate 10 (hereinafter, also simply referred to as a “cutting tool”) (see FIG. 2). Coating 40 includes an alumina layer 20 provided on substrate 10, an intermediate layer 21 provided directly on alumina layer 20, and a titanium carbonitride layer 22 provided directly on intermediate layer 21. In addition to the layers described above, cutting tool 50 may further comprise an underlying layer 23 provided between substrate 10 and alumina layer 20 (see FIG. 3). Cutting tool 50 may further comprise a surface layer 24 provided on titanium carbonitride layer 22 (see FIG. 3). Underlying layer 23, surface layer 24 and other layers will be described hereinafter.

In one aspect of the present embodiment, the coating may coat a rake face of the substrate or may coat a portion other than the rake face (e.g., a flank face). The cutting tool can for example be a drill, an end mill, an indexable cutting insert for a drill, an indexable cutting insert for an end mill, an indexable cutting insert for milling, an indexable cutting insert for turning, a metal saw, a gear cutting tool, a reamer, a tap, or the like.

### <Substrate>

The substrate of the present embodiment can be any substrate conventionally known as a substrate of this type. For example, the substrate may include at least one selected from the group consisting of a cemented carbide (for example, a tungsten carbide (WC)-base cemented carbide, a cemented carbide containing Co other than WC, a cemented carbide with a carbonitride of Cr, Ti, Ta, Nb, or the like other than WC added, or the like), a cermet (containing Tic, TiN, TiCN, or the like as a major component), a high-speed steel, ceramics (titanium carbide, silicon carbide, silicon nitride, aluminum nitride, aluminum oxide, and the like), a cubic boron nitride sintered material (a cBN sintered material), and a diamond sintered material, and may include at least one selected from the group consisting of cemented carbide, cermet, and cBN sintered material.

Of these various types of substrates, a WC-base cemented carbide or a cBN sintered material may be selected. This is because these substrates are excellent in balance between hardness and strength at high temperature, in particular, and present excellent characteristics as a substrate for a cutting tool for the above-described applications.

When a cemented carbide is used as a substrate, the present embodiment is still effective even if the cemented carbide has a structure including free carbon or an extraordinary phase referred to as n phase. Note that the substrate used in the present embodiment may have its surface modified. For example, for the cemented carbide, the surface may be provided with a β-free layer, and for the cBN sintered material, the surface may be provided with a surface hardened layer, and even if the surface is thus modified, the present embodiment is still effective.

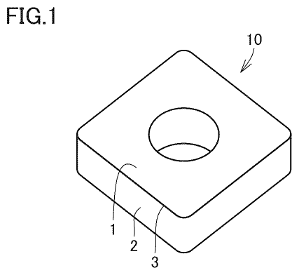

FIG. 1 is a perspective view for illustrating the substrate of the cutting tool in one manner. A substrate having such a shape is used as, for example, an indexable cutting insert for turning. Substrate 10 has a rake face 1, a flank face 2, and a cutting edge ridge portion 3 where rake face 1 and flank face 2 meet. That is, rake face 1 and flank face 2 are faces that are connected with cutting edge ridge portion 3 interposed therebetween. Cutting edge ridge portion 3 constitutes a tip of a cutting edge of substrate 10. Such a shape of substrate 10 can also be understood as a shape of the cutting tool.

When the cutting tool is an indexable cutting insert, substrate 10 also includes a shape with or without a chip breaker. Cutting edge ridge portion 3 is shaped to include any of a sharp edge (a ridge formed by a rake face and a flank face meeting each other), a honed edge (a sharp edge processed to be rounded), a negative land (with beveling applied), and a combination of the honed edge and the negative land.

While the shape of substrate 10 and the name of each part thereof have been described with reference to FIG. 1, a shape in cutting tool 50 according to the present embodiment that corresponds to substrate 10 and the name of each part thereof will be indicated by similar terminology. That is, the cutting tool has a rake face, a flank face, and a cutting edge ridge portion connecting the rake face and the flank face together.

### <Coating>

Coating 40 according to the present embodiment includes alumina layer 20 provided on substrate 10, intermediate layer 21 provided directly on alumina layer 20, and titanium carbonitride layer 22 provided directly on intermediate layer 21 (see FIG. 2). The “coating” coats at least a part of the substrate (for example, a rake face coming into contact with a workpiece during cutting) to exhibit a function to improve the cutting tool's various characteristics such as breaking resistance, wear resistance, welding resistance, peeling resistance, and the like. The coating may coat not only a part of the substrate but also the entire surface of the substrate. However, even if the substrate is partially uncoated with the coating or the coating is partially different in configuration, such does not depart from the scope of the present embodiment.

The coating may have a thickness of 6 μm or more and 30 μm or less, and may have a thickness of 6 μm or more and 25 μm or less. Note that the thickness of the coating means a total in thickness of any layers constituting the coating. A “layer constituting the coating” includes an alumina layer, an intermediate layer, a titanium carbonitride layer, an underlying layer, a surface layer, and the like described hereinafter. For example, the thickness of the coating can be determined by measuring any 10 points in a sample in a cross section parallel to the direction of a normal to a surface of the substrate with a field-emission scanning electron microscope (SEM), and calculating an average value of the measured 10 points in thickness. Note that when this is done, the sample in the cross section has a cross section ion-milled and thus polished for measurement. The alumina, intermediate, titanium carbonitride, underlying, and surface layers, etc. described hereinafter are also similarly handled when the layers are measured in thickness. An example of the field emission scanning electron microscope is SU3500 (trade name) manufactured by Hitachi High-Tech Corporation. An example of an apparatus for ion milling is IM4000 (trade name) manufactured by Hitachi High-Tech Corporation.

### (Alumina Layer)

Alumina layer 20 in the present embodiment is provided on substrate 10. Herein, being “provided on the substrate” is not limited to being provided directly on the substrate (see FIG. 2), and also includes being provided on the substrate via another layer (see FIG. 3). That is, the alumina layer may be provided directly on the substrate or may be provided on the substrate via another layer such as an underlying layer described hereinafter insofar as it achieves an effect of the present disclosure.

The alumina layer may be composed of aluminum oxide (Al₂O₃) alone, or may be composed of aluminum oxide and inevitable impurities. Examples of the inevitable impurities include chlorine, sulfur, etc. The aluminum oxide may be α-type aluminum oxide (α-Al₂O₃).

The alumina layer may have a thickness of 2 μm or more and 20 μm or less, 3 μm or more and 15 μm or less, or 4 μm or more and 10 μm or less. The thickness of the alumina layer can be confirmed by observing a vertical cross section of the substrate and the coating with a SEM, similarly as has been described above.

### (Intermediate Layer)

Intermediate layer 21 according to the present embodiment is provided directly on alumina layer 20 (see FIG. 2). The intermediate layer is made of titanium oxycarbonitride. In one aspect of the present embodiment, the intermediate layer may be composed of titanium oxycarbonitride alone, or may be composed of titanium oxycarbonitride and inevitable impurities. Examples of the inevitable impurities include oxygen, chlorine etc.

The intermediate layer may have a thickness of 0.5 μm or more and 1.5 μm or less, 0.6 μm or more and 1.4 μm or less, or 0.7 μm or more and 1.3 μm or less. The thickness of the intermediate layer can be confirmed by observing a vertical cross section of the substrate and the coating with a SEM, similarly as has been described above.

### (Titanium Carbonitride Layer)

Titanium carbonitride layer 22 in the present embodiment is provided directly on intermediate layer 21. The titanium carbonitride layer is made of a compound represented by TiₓC_{y}N_{(1-y)}. Another layer such as a surface layer may be provided on the titanium carbonitride layer. The titanium carbonitride layer may be an outermost surface of the coating.

### (Atomic Ratio at Points in Titanium Carbonitride Layer)

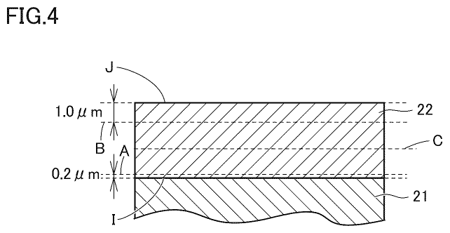

In the present embodiment, a point A in titanium carbonitride layer 22 is a point 0.2 μm away from an interface I between intermediate layer 21 and titanium carbonitride layer 22 in a depthwise direction toward titanium carbonitride layer 22 (see FIG. 4). A point B in titanium carbonitride layer 22 is a point 1.0 μm away from an interface J at titanium carbonitride layer 22 opposite to interface I in the depthwise direction toward titanium carbonitride layer 22 (see FIG. 4). Interface J may be parallel to interface I. In the present embodiment, being “parallel” is an idea which is not limited to being geometrically parallel and also includes being generally parallel. When titanium carbonitride layer 22 is located at an outermost surface of the coating, interface J can be understood as a surface of titanium carbonitride layer 22. When another layer (for example, a surface layer) is provided directly on the titanium carbonitride layer, interface J can be understood as an interface between the titanium carbonitride layer and the other layer. A point C in titanium carbonitride layer 22 is a midpoint between points A and B (see FIG. 4). Point C can also be understood as a point which is located on a straight line connecting points A and B and is equidistant from each of points A and B.

At point A, the titanium carbonitride layer may have an atomic ratio x_{A} of 1.3 or more and 1.6 or less for titanium, and may have an atomic ratio x_{A} of 1.4 or more and 1.5 or less for titanium.

At point A, the titanium carbonitride layer may have an atomic ratio y_{A} of 0.4 or more and 0.6 or less for carbon, and may have an atomic ratio y_{A} of 0.45 or more and 0.55 or less for carbon.

In one aspect of the present embodiment, at point A,
the titanium carbonitride layer may have an atomic ratio x_{A} of 1.4 or more and 1.5 or less for titanium, and
the titanium carbonitride layer may have an atomic ratio y_{A} of 0.45 or more and 0.55 or less for carbon.

Herein, an “atomic ratio x_{A}” and an “atomic ratio y_{A}” mean an “atomic ratio x at point A” and an “atomic ratio y at point A”, respectively. An “atomic ratio x_{B}”, an “atomic ratio y_{B}”, an “atomic ratio x_{C}” and an “atomic ratio y_{C}” described hereinafter are also similarly discussed. These atomic ratios are atomic ratios with reference to a total of atomic ratios of carbon and nitrogen in the titanium carbonitride layer.

The atomic ratio of each element (e.g., titanium, carbon, nitrogen, and oxygen) can be determined by subjecting the above-described sample in the cross section parallel to the direction of the normal to the surface of the substrate to a line analysis using an energy dispersive x-ray spectrometer (an EDX device) accompanying an SEM. Specifically, initially, a cross section polisher (CP) or the like is used to polish a cut surface of the sample in the cross section. The polished cut surface undergoes a line analysis in a direction intersecting the intermediate layer and the titanium carbonitride layer using the EDX device. The “direction intersecting the intermediate layer and the titanium carbonitride layer” may further be a direction also perpendicular to interface I. This is done with a measurement pitch of 0.1 μm. An example of the EDX measurement device is JED-2300 (trade name) manufactured by JEOL.

Subsequently, based on a result of the line analysis, a graph is created in which a distance from a measurement starting point is plotted along an X axis (or a horizontal axis) and an atomic ratio (at %) of each element to be measured is plotted along a Y axis (or a vertical axis). Based on this graph, a point having no detectable atomic ratio (1 at % or less) for oxygen and closer to the intermediate layer, is defined as an “interface I between the intermediate layer and the titanium carbonitride layer” (see FIG. 4). Further, based on this graph, a point having an atomic ratio of 1 at % for carbon and farthest from the intermediate layer, is defined as an “interface J”. Points A, B, and C are determined from interfaces I and J. Then, the atomic ratio of each element at each of points A, B, and C is determined based on the graph.

The above-described measurement is performed at least three times, and an average value of atomic ratios of each element determined in the measurements is defined as “atomic ratio x_{A}”, “atomic ratio y_{A}”, “atomic ratio x_{B}”, “atomic ratio y_{B}”, “atomic ratio x_{C}”, and “atomic ratio y_{C}”.

At point B, the titanium carbonitride layer has an atomic ratio x_{B} of 0.8 or more and 1.2 or less for titanium, and may have an atomic ratio x_{B} of 0.8 or more and 1.1 or less for titanium or may have an atomic ratio x_{B} of 0.9 or more and 1.1 or less for titanium.

At point B, the titanium carbonitride layer has an atomic ratio y_{B} of 0.3 or more and 0.5 or less for carbon, and may have an atomic ratio y_{B} of 0.3 or more and 0.45 or less for carbon or may have an atomic ratio y_{B} of 0.3 or more and 0.4 or less for carbon.

In one aspect of the present embodiment, at point B,
the titanium carbonitride layer may have an atomic ratio x_{B} of 0.8 or more and 1.1 or less for titanium and
the titanium carbonitride layer may have an atomic ratio y_{B} of 0.3 or more and 0.45 or less for carbon, and
the titanium carbonitride layer may have an atomic ratio x_{B} of 0.9 or more and 1.1 or less for titanium and
the titanium carbonitride layer may have an atomic ratio y_{B} of 0.3 or more and 0.4 or less for carbon.

At point C, the titanium carbonitride layer has an atomic ratio x_{C} larger than the atomic ratio x_{B} and less than the atomic ratio x_{A} for titanium.

At point C, the titanium carbonitride layer has an atomic ratio y_{C} larger than the atomic ratio y_{B} and less than the atomic ratio y_{A} for carbon.

In one aspect of the present embodiment, the titanium carbonitride layer may or may not have an interface in the layer. It is needless to say that the interface present in the layer cannot be interface I or interface J.

Conventionally, a titanium oxycarbonitride layer has been formed on a titanium carbonitride layer. In that case, needle crystals of titanium oxycarbonitride are formed on the titanium carbonitride layer (columnar crystals). Therefore, the two layers are improved in peeling resistance by an anchor effect of the needle crystal. However, when the titanium carbonitride layer and the titanium oxycarbonitride layer are deposited in the opposite order, the above-described anchor effect cannot be obtained, and there is room for improvement in the peeling resistance of the two layers when the titanium carbonitride layer is formed directly on the titanium oxycarbonitride layer. The titanium carbonitride layer according to the present disclosure has titanium atoms present therein locally on a side closer to the intermediate layer. This helps carbon and nitrogen constituting the intermediate layer to diffuse into the titanium carbonitride layer, and thus improves peeling resistance without depending on the two layers' crystalline state while maintaining the titanium carbonitride layer's wear resistance.

The titanium carbonitride layer may have a thickness of 1.5 μm or more and 3.5 μm or less, 1.7 μm or more and 3.3 μm or less, or 2.0 μm or more and 3.0 μm or less. The thickness of the titanium carbonitride layer can be confirmed by observing a vertical cross section of the substrate and the coating with a SEM, similarly as has been described above.

### (Underlying Layer)

Coating 40 may further include underlying layer 23 provided between substrate 10 and alumina layer 20 (see FIG. 3). Underlying layer 23 may include titanium nitride (TiN), titanium carbonitride (TiCN), or titanium oxycarbonitride (TiCNO). TiN, TiCN and TiCNO may each be a cubic crystal.

The underlying layer may have a thickness of 3 μm or more and 20 μm or less, or may have a thickness of 5 μm or more and 15 μm or less. Such a thickness can be confirmed by observing a vertical cross section of the substrate and the coating with a SEM, similarly as has been described above.

### (Surface Layer)

Coating 40 may further include surface layer 24 provided on titanium carbonitride layer 22. Surface layer 24 may include a compound consisting of elemental titanium and at least one element selected from the group consisting of C, N and B. In one aspect of the present embodiment, the surface layer may be different in composition from the titanium carbonitride layer.

Examples of the compound included in surface layer 24 include TiC, TiN, TiCN, and TiB₂.

The surface layer may have a thickness of 0.1 μm or more and 1.5 μm or less, or may have a thickness of 0.2 μm or more and 1.0 μm or less. Such a thickness can be confirmed by observing a vertical cross section of the substrate and the coating with a SEM, similarly as has been described above.

### (Another Layer)

The coating may further include another layer insofar as it does not impair an effect of the cutting tool according to the present embodiment. The other layer may have a composition different from or identical to that of the alumina layer, the intermediate layer, the titanium carbonitride layer, the underlying layer or the surface layer. Examples of the compound included in the other layer include TiN, TiCN, TiBN, and Al₂O₃ for example. The other layer is not limited, either, in in what order it is stacked. While the other layer is not particularly limited in thickness insofar as it does not impair an effect of the present embodiment, it is for example 0.1 μm or more and 20 μm or less.

### <<Method for Manufacturing the Cutting Tool>>

A method for manufacturing a cutting tool according to the present embodiment comprises:
a first step of preparing the substrate (hereinafter also simply referred to as a “first step”);
a second step of forming the alumina layer on the substrate through chemical vapor deposition (hereinafter also simply referred to as a “second step”);
a third step of forming the intermediate layer directly on the alumina layer through chemical vapor deposition (hereinafter also simply referred to as a “third step”); and
a fourth step of forming the titanium carbonitride layer directly on the intermediate layer through chemical vapor deposition (hereinafter also simply referred to as a “fourth step”), wherein
in the fourth step, the titanium carbonitride layer is formed using a source gas including a gas containing titanium as a constituent element, a gas containing nitrogen as a constituent element, and a gas containing carbon as a constituent element at a temperature of 950° C. or higher and 1030° C. or lower while reducing a flow rate of the gas containing titanium as a constituent element and increasing a flow rate of the gas containing nitrogen as a constituent element.

### <First Step: Step of Preparing a Substrate>

In the first step, a substrate is prepared. For example, a cemented carbide substrate is prepared as the substrate. The cemented carbide substrate may be a commercially available product or may be manufactured in a typical powder metallurgy method. When manufacturing the substrate in a typical powder metallurgy method, for example, WC powder and Co powder are mixed using a ball mill or the like to obtain a powdery mixture. After the powdery mixture is dried, it is shaped into a prescribed shape to obtain a shaped body. The shaped body is sintered to obtain a WC-Co based cemented carbide (a sintered material). Subsequently, the sintered material can be honed or subjected to a prescribed process for a cutting edge to prepare a substrate made of the WC-Co based cemented carbide. In the first step, any other substrate may be prepared insofar as it is a substrate conventionally known as a substrate of this type.

### <Second Step: Step of Forming an Alumina Layer on the Substrate>

In the second step, an alumina layer is formed on the substrate through chemical vapor deposition (CVD). In the second step, the alumina layer is formed using a source gas including a gas containing aluminum as a constituent element and a gas containing oxygen as a constituent element.

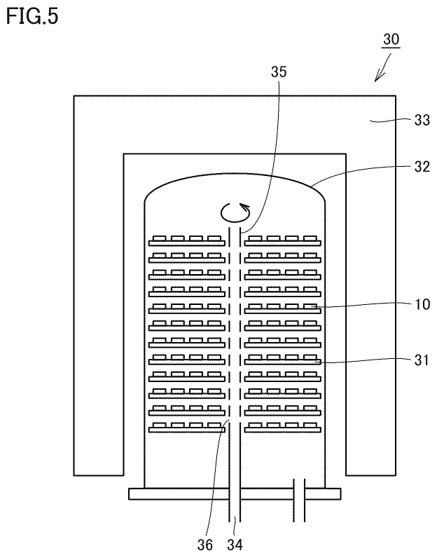

FIG. 5 is a schematic cross section showing an example of a chemical vapor deposition (CVD) apparatus used for producing a coating. Hereinafter, the second step will be described with reference to FIG. 5. A CVD apparatus 30 includes a plurality of substrate setting jigs 31 for holding substrate 10, and a reaction chamber 32 made of heat-resistant alloy steel and covering substrate setting jigs 31. A temperature controller 33 is provided around reaction chamber 32 for controlling the temperature inside reaction chamber 32. Reaction chamber 32 is provided with a gas introduction pipe 35 having a gas introduction port 34. Gas introduction pipe 35 is disposed in an internal space of reaction chamber 32 in which substrate setting jig 31 is disposed, such that the gas introduction pipe extends in the vertical direction rotatably about the vertical direction. Furthermore, gas introduction pipe 35 is provided with a plurality of jetting holes 36 for jetting gas into reaction chamber 32. CVD apparatus 30 can be used to form the alumina layer etc. constituting the coating, as follows:

Initially, substrate 10 is placed on substrate setting jig 31, and a source gas for the alumina layer is introduced into reaction chamber 32 through gas introduction pipe 35 while controlling temperature and pressure inside reaction chamber 32 to each fall within a prescribed range. Thus, alumina layer 20 is formed on substrate 10. Note that before forming alumina layer 20 (that is, before the second step), an underlying layer (e.g., a layer including TiN) may be formed on a surface of substrate 10 by introducing a source gas for the underlying layer through gas introduction pipe 35 into reaction chamber 32. Hereinafter will be described a method for forming alumina layer 20 after the underlying layer is formed on the surface of substrate 10.

While the source gas for the underlying layer is not particularly limited, an example thereof is a gaseous mixture of TiCl₄ and N₂ when a layer of TiN is formed for example. When a layer of TiCN is formed, a gaseous mixture of TiCl₄, N₂, CH₃CN, CH₄, and C₂H₄, may for example be used as the source gas. When a layer of TiCNO is formed, a gaseous mixture of TiCl₄, N₂, CO, and CH₄ may for example be used as the source gas.

In forming the underlying layer, reaction chamber 32 may have an internal temperature controlled to 1000 to 1100° C. In forming the underlying layer, reaction chamber 32 may have an internal pressure controlled to 0.1 to 1013 hPa. H₂ may be used as a carrier gas. When introducing a gas, gas introduction pipe 35 may be rotated by a drive unit (not shown). This allows each gas to be uniformly dispersed in reaction chamber 32.

Further, the underlying layer may be formed through MT (Medium Temperature)-CVD. In contrast to CVD performed at a temperature of 1000 to 1100° C. (hereinafter also referred to as “HT-CVD”), MT-CVD is a method to form a layer while the temperature inside reaction chamber 32 is maintained at a relatively low temperature of 850 to 950° C. Since MT-CVD is performed at a relatively lower temperature than HT-CVD, it can reduce damage to substrate 10 caused by heating. In particular, when the underlying layer is a TiN layer, the layer may be formed through MT-CVD.

Subsequently, the alumina layer is formed on the underlying layer. As a source gas therefor, a gaseous mixture of AlCl₃, CO, CO₂, HCl, and H₂S may be used for example.

The source gas may have an AlCl₃ content of 1 to 5% by volume, 1.5 to 4% by volume, or 2 to 3.5% by volume. The flow rate of AlCl₃ may for example be 0.5 to 3.5 L/min.

The source gas may have a CO content of 0.5 to 4% by volume, 0.8 to 3.5% by volume, or 1 to 2.5% by volume. The flow rate of CO may for example be 0.5 to 2 L/min.

The source gas may have a CO₂ content of 0.2 to 2.5% by volume, 0.3 to 2% by volume, or 0.5 to 1.5% by volume. The flow rate of CO₂ may for example be 0.4 to 1.5 L/min.

The source gas may have a HCl content of 1 to 6% by volume, 1.5 to 5.5% by volume, or 2 to 4.5% by volume. The flow rate of HCl may for example be 0.5 to 4.5 L/min.

The source gas may have a H₂S content of 0.5 to 3.5% by volume, 1.0 to 3.0% by volume, or 1.5 to 2.5% by volume. The flow rate of H₂S may for example be 0.3 to 2.5 L/min.

Reaction chamber 32 may have an internal temperature controlled to 950 to 1000° C. Reaction chamber 32 may have an internal pressure controlled to 50 to 100 hPa. H₂ can be used as a carrier gas. Gas introduction pipe 35 may be rotated when introducing a gas, similarly as has been described above.

In the above manufacturing method, controlling each condition for CVD varies each layer in manner. For example, each layer's composition is determined by a composition of a source gas introduced into reaction chamber 32. Each layer is controlled in thickness by execution time (or deposition time).

### <Third Step: Step of Forming an Intermediate Layer Directly on the Alumina Layer>

In the third step, the intermediate layer is formed directly on the alumina layer through chemical vapor deposition. The intermediate layer is made of titanium oxycarbonitride.

For example, a gaseous mixture of TiCl₄, CH₄, N₂, and CO may be used as a source gas for the titanium oxycarbonitride layer.

The source gas may have a TiCl₄ content of 2 to 7% by volume, 3 to 6% by volume, or 3.5 to 5.5% by volume. The flow rate of TiCl₄ may for example be 1.4 to 4.9 L/min.

The source gas may have a CH₄ content of 2 to 7% by volume, 2.5 to 6.5% by volume, or 3 to 6% by volume. The flow rate of CH₄ may for example be 1 to 5 L/min.

The source gas may have a N₂ content of 5 to 35% by volume, 7.5 to 30% by volume, or 10 to 25% by volume. The flow rate of N₂ may for example be 3.5 to 24.5 L/min.

The source gas may have a CO content of 1.5 to 4.5% by volume, 2.0 to 4.0% by volume, or 2.5 to 3.5% by volume. The flow rate of CO may for example be 0.8 to 2.3 L/min.

Reaction chamber 32 may have an internal temperature controlled to 950 to 1000° C. Reaction chamber 32 may have an internal pressure controlled to 50 to 200 hPa. H₂ can be used as a carrier gas. Gas introduction pipe 35 may be rotated when introducing a gas, similarly as has been described above.

### <Fourth Step: Step of Forming a Titanium Carbonitride Layer Directly on the Intermediate Layer>

In the fourth step, a titanium carbonitride layer is formed directly on the intermediate layer through chemical vapor deposition. In the fourth step, the titanium carbonitride layer is formed using a source gas including a gas containing titanium as a constituent element, a gas containing nitrogen as a constituent element, and a gas containing carbon as a constituent element at a temperature of 950° C. or higher and 1030° C. or lower while reducing the flow rate of the gas containing titanium as a constituent element and increasing the flow rate of the gas containing nitrogen as a constituent element. In one aspect of the present embodiment, the source gas in the fourth step may be provided at a flow rate of 80 to 120 L/min. The flow rate of the source gas can also be understood as a sum of the flow rates of the gases constituting the source gas.

As the source gas, for example, a gaseous mixture of TiCl₄ (a gas containing titanium as a constituent element), CH₄ (a gas containing carbon as a constituent element), CH₃CN, and N₂ (a gas containing nitrogen as a constituent element) is used.

The source gas may have a TiCl₄ content of 0.5 to 4% by volume, 1.0 to 3.5% by volume, or 1.5 to 3.0% by volume. The flow rate of TiCl₄ may for example be 0.35 to 2.8 L/min.

The source gas may have a CH₄ content of 2 to 7% by volume, 2.5 to 6.5% by volume, or 3 to 6% by volume. The flow rate of CH₄ may for example be 1 to 5 L/min.

The source gas may have a CH₃CN content of 0.1 to 0.5% by volume, 0.1 to 0.4% by volume, or 0.1 to 0.3% by volume. The flow rate of CH₃CN may for example be 0.07 to 0.35 L/min.

The source gas may have a N₂ content of 5 to 60% by volume, 7.5 to 55% by volume, or 10 to 50% by volume. The flow rate of N₂ may for example be 3.5 to 42 L/min.

Reaction chamber 32 may have an internal temperature controlled to 950 to 1000° C. Reaction chamber 32 may have an internal pressure controlled to 50 to 200 hPa. H₂ can be used as a carrier gas. Gas introduction pipe 35 may be rotated when introducing a gas, similarly as has been described above.

In one aspect of the present embodiment, the fourth step may be performed at a temperature of 950° C. or higher and 1030° C. or lower, or 980° C. or higher and 1010° C. or lower.

In the fourth step, the flow rate of the gas containing titanium as a constituent element may be reduced at a rate of 0.05 L/min² or more and 0.5 L/min² or less, or 0.05 L/min² or more and 0.3 L/min² or less.

In the fourth step, the flow rate of the gas containing nitrogen as a constituent element may be increased at a rate of 0.01 L/min² or more and 1.0 L/min² or less, or 0.05 L/min² or more and 0.5 L/min² or less.

### <Another Step>

In the manufacturing method according to the present embodiment, in addition to the steps described above, an additional step may be performed, as appropriate, within a range that does not impair an effect of the present embodiment. Examples of the additional step include the step of forming a surface layer on the titanium carbonitride layer, the step of blasting the coating, etc. The surface layer may be formed in any method, and the layer is formed for example through CVD.

### EXAMPLES

Hereinafter, the present invention will more specifically be described with reference to examples although the present invention is not limited thereto.

### <<Manufacturing a Cutting Tool>>

### <First Step: Step of Preparing a Substrate>

As a substrate was prepared a cutting insert of cemented carbide (shape: CNMG120408 N-UX, manufactured by Sumitomo Electric Hardmetal Ltd., JIS B4120 (2013)) having a composition composed of TaC (2.0% by mass), NbC (1.0% by mass), Co (10.0% by mass) and WC (balance) (including inevitable impurity).

### <Step of Forming an Underlying Layer>

For samples 21, 23 and 24, before the second step described hereinafter is performed, a CVD apparatus was used to form an underlying layer with source gas compositions under conditions for deposition, as shown in Table 1. The deposition time was adjusted, as appropriate, to provide thickness shown in Table 5-2. Furthermore, the underlying layer's thickness and composition are shown in Table 5-2. Table 5-2 indicates the underlying layer's composition together with its thickness. For example, “TiCN (3)” means that a layer of TiCN (thickness: 3 μm) is formed.

TABLE 1

| | | | | | | | | total gas | | |
|---|---|---|---|---|---|---|---|---|---|---|
| underlying | source gas composition (Vol %) | | | | | | | flow rate | pressure | temperature |
| layer | TiCl₄ | Na | CH₃CN | CH₄ | C₂H₄ | CO | H₂ | (L/min) | (hPa) | (C) |
| TiN | 3.0 | 24.0 | — | — | — | — | balance | 58 | 200 | 900 |
| TiCN | 4.0 | 20.0 | 0.7 | 1.0 | 0.5 | — | balance | 95 | 80 | 880 |
| TiCNO | 2.0 | 24.0 | — | 2.8 | — | 3.2 | balance | 50 | 250 | 980 |

### <Second Step: Step of Forming an Alumina Layer on the Substrate>

A CVD apparatus was used to form an alumina layer on the prepared substrate or the substrate with the underlying layer formed thereon, and the step is shifted to a subsequent, third step. The alumina layer was deposited under a condition indicated in Table 2. The deposition time was adjusted, as appropriate, to provide thickness shown in Tables 5-1 and 5-2. Furthermore, the alumina layer's thickness is shown in Tables 5-1 and 5-2.

TABLE 2

| | | | | | | | | total gas | | |
|---|---|---|---|---|---|---|---|---|---|---|
| alumina | source gas composition (Vol %) | | | | | | | flow rate | pressure | temperature |
| layer | AlCl₃ | CO | CO₂ | HCl | H₂S | N₂ | H₂ | (L/min) | (hPa) | (° C.) |
| α-Al₂O₃ | 3.2 | 2.5 | 1.0 | 4.5 | 2.0 | — | balance | 70 | 65 | 1000 |

### <Third Step: Step of Forming an Intermediate Layer on the Alumina Layer>

Subsequently, a CVD apparatus was used to form an intermediate layer (a layer formed of titanium oxycarbonitride) directly on the alumina layer. The intermediate layer was formed under a condition indicated in Table 3. The deposition time was adjusted, as appropriate, to provide thickness shown in Tables 5-1 and 5-2. Furthermore, the intermediate layer's thickness is shown in Tables 5-1 and 5-2.

TABLE 3

| inter- | | | | | | total gas | pres- | temper- |
|---|---|---|---|---|---|---|---|---|
| mediate | source gas composition (Vol %) | | | | | flow rate | sure | ature |
| layer | TiCl₄ | N₂ | CH₄ | CO | H₂ | (L/min) | (hPa) | (° C.) |
| TiCNO | 3.0 | 20.0 | 2.2 | 2.8 | balance | 50 | 200 | 1000 |

### <Fourth Step: Step of Forming a Titanium Carbonitride Layer Directly on the Intermediate Layer>

Subsequently, a CVD apparatus was used to form a titanium carbonitride layer for the substrate with the intermediate layer formed thereon such that the titanium carbonitride layer is directly on the intermediate layer. The titanium carbonitride layer was formed under conditions indicated in Tables 4-1 to 4-4. For samples 21 to 24, the same forming condition as sample 18 was used. In the fourth step, as shown in Tables 4-1 to 4-4, the titanium carbonitride layer was formed while the composition of the source gas was changed from an early stage (of 5 minutes) through a middle stage (of 50 minutes) to a final stage (of 10 minutes). Specifically, the layer was deposited while the TiCl₄ gas was decreased and the N₂ gas was increased. The deposition time was adjusted, as appropriate, to provide thickness shown in Tables 5-1 and 5-2. Furthermore, the titanium carbonitride layer's thickness is shown in Tables 5-1 and 5-2.

TABLE 4-1

| | | | | | | | rate to | rate to | | | |
|---|---|---|---|---|---|---|---|---|---|---|---|
| titanium | | | | | | | decrease | increase | total gas | | |
| carbonitride | | source gas composition (Vol %) | | | | | TiCl₄ gas | N₂ gas | flow rate | pressure | temperature |
| layer | samples | TiCl₄ | N₂ | CH₄ | CH₃CN | H₂ | (L/min²) | (L/min²) | (L/min) | (hPa) | (° C.) |
| early stage | 1 | 2.0 | 20 | 3.0 | 0.4 | balance | 0.1 | 0.2 | 70 | 90 | 1000 |
| middle stage | | 1.7 | 25 | 3.0 | 0.4 | balance | | | | | |
| final stage | | 1.4 | 30 | 3.0 | 0.4 | balance | | | | | |
| early stage | 2 | 2.3 | 20 | 3.0 | 0.4 | balance | 0.15 | 0.2 | 70 | 90 | 1000 |
| middle stage | | 1.9 | 25 | 3.0 | 0.4 | balance | | | | | |
| final stage | | 1.4 | 30 | 3.0 | 0.4 | balance | | | | | |
| early stage | 3 | 2.5 | 20 | 3.0 | 0.4 | balance | 0.2 | 0.2 | 70 | 90 | 1000 |
| middle stage | | 2.0 | 25 | 3.0 | 0.4 | balance | | | | | |
| final stage | | 1.4 | 30 | 3.0 | 0.4 | balance | | | | | |
| early stage | 4 | 3.0 | 20 | 3.0 | 0.4 | balance | 0.3 | 0.2 | 70 | 90 | 1000 |
| middle stage | | 2.2 | 25 | 3.0 | 0.4 | balance | | | | | |
| final stage | | 1.4 | 30 | 3.0 | 0.4 | balance | | | | | |
| early stage | 5 | 3.5 | 20 | 3.0 | 0.4 | balance | 0.35 | 0.2 | 70 | 90 | 1000 |
| middle stage | | 2.5 | 25 | 3.0 | 0.4 | balance | | | | | |
| final stage | | 1.4 | 30 | 3.0 | 0.4 | balance | | | | | |

TABLE 4-2

| | | | | | | | rate to | rate to | | | |
|---|---|---|---|---|---|---|---|---|---|---|---|
| titanium | | | | | | | decrease | increase | total gas | | |
| carbonitride | | source gas composition (Vol %) | | | | | TiCl₄ gas | N₂ gas | flow rate | pressure | temperature |
| layer | samples | TiCl₄ | N₂ | CH₄ | CH₃CN | H₂ | (L/min²) | (L/min²) | (L/min) | (hPa) | (° C.) |
| early stage | 6 | 2.5 | 50 | 3.0 | 0.15 | balance | 0.2 | −0.1 | 70 | 90 | 1000 |
| middle stage | | 1.9 | 45 | 3.0 | 0.16 | balance | | | | | |
| final stage | | 1.4 | 40 | 3.0 | 0.17 | balance | | | | | |
| early stage | 7 | 2.5 | 30 | 3.0 | 0.2 | balance | 0.2 | 0.1 | 70 | 90 | 1000 |
| middle stage | | 1.9 | 35 | 3.0 | 0.19 | balance | | | | | |
| final stage | | 1.4 | 40 | 3.0 | 0.17 | balance | | | | | |
| early stage | 8 | 2.5 | 20 | 3.0 | 0.4 | balance | 0.2 | 0.3 | 70 | 90 | 1000 |
| middle stage | | 1.9 | 30 | 3.0 | 0.29 | balance | | | | | |
| final stage | | 1.4 | 40 | 3.0 | 0.17 | balance | | | | | |
| early stage | 9 | 2.5 | 15 | 4.0 | 0.3 | balance | 0.2 | 0.5 | 70 | 90 | 1000 |
| middle stage | | 1.9 | 28 | 3.5 | 0.24 | balance | | | | | |
| final stage | | 1.4 | 40 | 3.0 | 0.17 | balance | | | | | |
| early stage | 10 | 2.5 | 10 | 5.0 | 0.3 | balance | 0.2 | 0.7 | 70 | 90 | 1000 |
| middle stage | | 1.9 | 25 | 4.0 | 0.24 | balance | | | | | |
| final stage | | 1.4 | 40 | 3.0 | 0.17 | balance | | | | | |

TABLE 4-3

| | | | | | | | rate to | rate to | | | |
|---|---|---|---|---|---|---|---|---|---|---|---|
| titanium | | | | | | | decrease | increase | total gas | | |
| carbonitride | | source gas composition (Vol %) | | | | | TiCl₄ gas | N₂ gas | flow rate | pressure | temperature |
| layer | samples | TiCl₄ | N₂ | CH₄ | CH₃CN | H₂ | (L/min²) | (L/min²) | (L/min) | (hPa) | (° C.) |
| early stage | 11 | 2.5 | 20 | 3.0 | 0.4 | balance | 0.35 | 0.2 | 70 | 90 | 1000 |
| middle stage | | 1.8 | 25 | 3.0 | 0.4 | balance | | | | | |
| final stage | | 1.0 | 30 | 3.0 | 0.4 | balance | | | | | |
| early stage | 12 | 2.5 | 20 | 3.0 | 0.4 | balance | 0.3 | 0.2 | 70 | 90 | 1000 |
| middle stage | | 1.9 | 25 | 3.0 | 0.4 | balance | | | | | |
| final stage | | 1.2 | 30 | 3.0 | 0.4 | balance | | | | | |
| early stage | 13 | 2.5 | 20 | 3.0 | 0.4 | balance | 0.2 | 0.2 | 70 | 90 | 1000 |
| middle stage | | 2.0 | 25 | 3.0 | 0.4 | balance | | | | | |
| final stage | | 1.4 | 30 | 3.0 | 0.4 | balance | | | | | |
| early stage | 14 | 2.5 | 20 | 3.0 | 0.4 | balance | 0.1 | 0.2 | 70 | 90 | 1000 |
| middle stage | | 2.3 | 25 | 3.0 | 0.4 | balance | | | | | |
| final stage | | 2.0 | 30 | 3.0 | 0.4 | balance | | | | | |
| early stage | 15 | 2.5 | 20 | 3.0 | 0.4 | balance | 0.05 | 0.2 | 70 | 90 | 1000 |
| middle stage | | 2.4 | 25 | 3.0 | 0.4 | balance | | | | | |
| final stage | | 2.3 | 30 | 3.0 | 0.4 | balance | | | | | |

TABLE 4-4

| | | | | | | | rate to | rate to | | | |
|---|---|---|---|---|---|---|---|---|---|---|---|
| titanium | | | | | | | decrease | increase | total gas | | |
| carbonitride | | source gas composition (Vol %) | | | | | TiCl₄ gas | N₂ gas | flow rate | pressure | temperature |
| layer | samples | TiCl₄ | N₂ | CH₄ | CH₃CN | H₂ | (L/min²) | (L/min²) | (L/min) | (hPa) | (° C.) |
| early stage | 16 | 2.5 | 20 | 3.0 | 0.4 | balance | 0.2 | 0.6 | 70 | 90 | 1000 |
| middle stage | | 2.0 | 40 | 3.0 | 0.25 | balance | | | | | |
| final stage | | 1.4 | 60 | 3.0 | 0.1 | balance | | | | | |
| early stage | 17 | 2.5 | 20 | 3.0 | 0.4 | balance | 0.2 | 0.4 | 70 | 90 | 1000 |
| middle stage | | 2.0 | 35 | 3.0 | 0.28 | balance | | | | | |
| final stage | | 1.4 | 50 | 3.0 | 0.15 | balance | | | | | |
| early stage | 18 | 2.5 | 20 | 3.0 | 0.4 | balance | 0.2 | 0.2 | 70 | 90 | 1000 |
| middle stage | | 2.0 | 25 | 3.0 | 0.4 | balance | | | | | |
| final stage | | 1.4 | 30 | 3.0 | 0.4 | balance | | | | | |
| early stage | 19 | 2.5 | 10 | 5.0 | 0.3 | balance | 0.2 | 0.2 | 70 | 90 | 1000 |
| middle stage | | 2.0 | 15 | 4.0 | 0.35 | balance | | | | | |
| final stage | | 1.4 | 20 | 3.0 | 0.4 | balance | | | | | |
| early stage | 20 | 2.5 | 20 | 3.0 | 0.4 | balance | 0.2 | −0.1 | 70 | 90 | 1000 |
| middle stage | | 2.0 | 15 | 4.0 | 0.35 | balance | | | | | |
| final stage | | 1.4 | 10 | 5.0 | 0.3 | balance | | | | | |

### <Step of Forming a Surface Layer>

For samples 22 to 24, a CVD apparatus was used to form a surface layer on the substrate with the titanium carbonitride layer formed thereon. The surface layer was formed under conditions indicated below. Furthermore, the surface layer's thickness and composition are shown in Table 5-2. Note that in Tables 5-1 and 5-2, “-” means that the layer of interest is not provided.

### (For TiN)

Source gas composition: TiCl₄ (8.0 vol %), N₂ (35.0 vol %), and H₂ (balance)

Total gas flow rate: 60 L/min

Pressure: 300 hPa

Temperature: 1005° C.

### (For TiC)

Source gas composition: TiCl₄ (3.5 vol %), CH₄ (4.5 vol %), and H₂ (balance)

Total gas flow rate: 40 L/min

Pressure: 80 hPa

Temperature: 1005° C.

TABLE 5-1

| | coating | | | | | |
|---|---|---|---|---|---|---|
| | | | inter- | titanium | | total |
| | underlying | alumina | mediate | carbonitride | surface | thick- |
| | layer | layer | layer | layer | layer | ness |
| samples | (μm) | (μm) | (μm) | (μm) | (μm) | (μm) |
| 1 | — | 8.0 | 1.0 | 2.5 | — | 11.5 |
| 2 | — | 8.0 | 1.0 | 2.5 | — | 11.5 |
| 3 | — | 8.0 | 1.0 | 2.5 | — | 11.5 |
| 4 | — | 8.0 | 1.0 | 2.5 | — | 11.5 |
| 5 | — | 8.0 | 1.0 | 2.5 | — | 11.5 |
| 6 | — | 8.0 | 1.0 | 2.5 | — | 11.5 |
| 7 | — | 8.0 | 1.0 | 2.5 | — | 11.5 |
| 8 | — | 8.0 | 1.0 | 2.5 | — | 11.5 |
| 9 | — | 8.0 | 1.0 | 2.5 | — | 11.5 |
| 10 | — | 8.0 | 1.0 | 2.5 | — | 11.5 |
| 11 | — | 8.0 | 1.0 | 2.5 | — | 11.5 |
| 12 | — | 8.0 | 1.0 | 2.5 | — | 11.5 |
| 13 | — | 8.0 | 1.0 | 2.5 | — | 11.5 |
| 14 | — | 8.0 | 1.0 | 2.5 | — | 11.5 |
| 15 | — | 8.0 | 1.0 | 2.5 | — | 11.5 |
| 16 | — | 8.0 | 1.0 | 2.5 | — | 11.5 |
| 17 | — | 8.0 | 1.0 | 2.5 | — | 11.5 |
| 18 | — | 8.0 | 1.0 | 2.5 | — | 11.5 |
| 19 | — | 8.0 | 1.0 | 2.5 | — | 11.5 |
| 20 | — | 8.0 | 1.0 | 2.5 | — | 11.5 |

TABLE 5-2

| | coating | | | | | |
|---|---|---|---|---|---|---|
| | | | inter- | titanium | | total |
| | underlying | alumina | mediate | carbonitride | surface | thick- |
| | layer | layer | layer | layer | layer | ness |
| samples | (μm) | (μm) | (μm) | (μm) | (μm) | (μm) |
| 21 | [TiCN] | 8.0 | 1.0 | 2.5 | — | 14.5 |
| | (3) | | | | | |
| 22 | — | 8.0 | 1.0 | 2.5 | [TiN] | 12.5 |
| | | | | | (1) | |
| 23 | [TiCN] | 8.0 | 1.0 | 2.5 | [TiN] | 15.5 |
| | (3) | | | | (1) | |
| 24 | [TiCN] | 8.0 | 1.0 | 2.5 | [TiN] | 19.5 |
| | (6) | | | | (2) | |

Through the above procedure, cutting tools for samples 1 to 24 were manufactured. Note that samples 2-4, 7-9, 12-14, 17-19, and 21-24 correspond to examples, and samples 1, 5, 6, 10, 11, 15, 16 and 20 correspond to comparative examples.

### <<Evaluating Characteristics of Cutting Tools>>

Using the cutting tools of the samples manufactured as described above, the cutting tools' characteristics were evaluated as follows:

### <Measuring Thickness of Each Layer Configuring the Coating>

The thickness of each layer configuring the coating was determined by measuring any 10 points in a sample in a cross section parallel to the direction of a normal to a surface of the substrate with a field-emission scanning electron microscope (SEM) (trade name: SU3500, manufactured by Hitachi High-Tech Corporation), and calculating an average value of the measured 10 points in thickness. Note that when this is done, the sample in the cross section has a cross section subjected to an ion-milling process (trade name: IM4000, available from Hitachi High-Tech Corporation) and thus polished for measurement. A result thereof is shown in Tables 5-1 and 5-2.

### <Atomic Ratio at Points in Titanium Carbonitride Layer (by EDX Measurement)>

The atomic ratio of each element (titanium, carbon, nitrogen, and oxygen) at each of points A, B, and C in the titanium carbonitride layer was determined by subjecting the above-described sample in the cross section parallel to the direction of the normal to the surface of the substrate to a line analysis using an energy dispersive x-ray spectrometer (an EDX device) accompanying an SEM. Specifically, initially, a cross section polisher was used to polish a cut surface of the sample in the cross section. The polished cut surface was subjected to a line analysis in a direction intersecting the intermediate layer and the titanium carbonitride layer (or a direction perpendicular to an interface I described hereinafter) using the EDX device. This was done with a measurement pitch of 0.1 μm.

### (Conditions for Measurement by EDX Device)

Measurement device: JED-2300 (trade name) manufactured by JEOL Ltd.

Based on a result of the line analysis, a graph was created in which a distance from a measurement starting point was plotted along an X axis (or a horizontal axis) and an atomic ratio (at %) of each element to be measured was plotted along a Y axis (or a vertical axis). Based on this graph, a point providing no detectable atomic ratio (1 at % or less) for oxygen and closer to the intermediate layer, was defined as an “interface I between the intermediate layer and the titanium carbonitride layer” (for example, see FIG. 4). Further, based on this graph, a point having an atomic ratio of 1 at % for carbon and farthest from the intermediate layer, was defined as an “interface J” (for example, see FIG. 4). Based on interfaces I and J, points A, B, and C in the titanium carbonitride layer were determined from the graph, as follows (for example, see FIG. 4):

Point A: a point 0.2 μm away from interface I in the depthwise direction toward the titanium carbonitride layer;

Point B: a point 1.0 μm away from interface J in the depthwise direction toward the titanium carbonitride; and

Point C: a point which is located on a straight line connecting points A and B and is equidistant from each of points A and B.

Then, the atomic ratio of each element at each of points A, B, and C in the titanium carbonitride layer was determined based on the graph. Such a measurement was performed three times, and an average value of atomic ratios of each element determined in the measurements was defined as “atomic ratio x_{A}”, “atomic ratio y_{A}”, “atomic ratio x_{B}”, “atomic ratio y_{B}”, “atomic ratio x_{C}”, and “atomic ratio y_{C}”. A result thereof is shown in Tables 6-1 and 6-2. Each atomic ratio in Tables 6-1 and 6-2 is an atomic ratio with reference to a total of atomic ratios of carbon and nitrogen in the titanium carbonitride layer.

TABLE 6-1

| | titanium carbonitride layer (TiₓC_{y}N_{1-y}) | | | | | | |
|---|---|---|---|---|---|---|---|
| | point A | | point C | | point B | | |
| | atomic | atomic | atomic | atomic | atomic | atomic | |
| | ratio | ratio | ratio | ratio | ratio | ratio | cutting |
| sam- | x_{A} for | y_{A} for | x_{C} for | y_{C} for | x_{B} for | y_{B} for | test |
| ples | titanium | carbon | titanium | carbon | titanium | carbon | (min) |
| 1 | 1.2 | 0.5 | 1.1 | 0.45 | 1.0 | 0.4 | 8 |
| 2 | 1.3 | 0.5 | 1.2 | 0.45 | 1.0 | 0.4 | 12 |
| 3 | 1.4 | 0.5 | 1.2 | 0.45 | 1.0 | 0.4 | 14 |
| 4 | 1.6 | 0.5 | 1.3 | 0.45 | 1.0 | 0.4 | 12 |
| 5 | 1.7 | 0.5 | 1.4 | 0.45 | 1.0 | 0.4 | 8 |
| 6 | 1.4 | 0.3 | 1.2 | 0.33 | 1.0 | 0.35 | 8 |
| 7 | 1.4 | 0.4 | 1.2 | 0.38 | 1.0 | 0.35 | 12 |
| 8 | 1.4 | 0.5 | 1.2 | 0.4 | 1.0 | 0.35 | 14 |
| 9 | 1.4 | 0.6 | 1.2 | 0.5 | 1.0 | 0.35 | 12 |
| 10 | 1.4 | 0.7 | 1.2 | 0.5 | 1.0 | 0.35 | 8 |
| 11 | 1.4 | 0.5 | 1.0 | 0.45 | 0.7 | 0.4 | 8 |
| 12 | 1.4 | 0.5 | 1.1 | 0.45 | 0.8 | 0.4 | 12 |
| 13 | 1.4 | 0.5 | 1.1 | 0.45 | 1.0 | 0.4 | 14 |
| 14 | 1.4 | 0.5 | 1.3 | 0.45 | 1.2 | 0.4 | 12 |
| 15 | 1.4 | 0.5 | 1.35 | 0.45 | 1.3 | 0.4 | 8 |
| 16 | 1.4 | 0.5 | 1.2 | 0.35 | 1.0 | 0.2 | 7 |
| 17 | 1.4 | 0.5 | 1.2 | 0.4 | 1.0 | 0.3 | 12 |
| 18 | 1.4 | 0.5 | 1.2 | 0.45 | 1.0 | 0.4 | 14 |
| 19 | 1.4 | 0.6 | 1.2 | 0.55 | 1.0 | 0.5 | 12 |
| 20 | 1.4 | 0.5 | 1.2 | 0.55 | 1.0 | 0.6 | 8 |

TABLE 6-2

| | titanium carbonitride layer (TiₓC_{y}N_{1-y}) | | | | | | |
|---|---|---|---|---|---|---|---|
| | point A | | point C | | point B | | |
| | atomic | atomic | atomic | atomic | atomic | atomic | |
| | ratio | ratio | ratio | ratio | ratio | ratio | cutting |
| sam- | x_{A} for | y_{A} for | x_{C} for | y_{C} for | x_{B} for | y_{B} for | test |
| ples | titanium | carbon | titanium | carbon | titanium | carbon | (min) |
| 21 | 1.4 | 0.5 | 1.2 | 0.45 | 1.0 | 0.4 | 14 |
| 22 | 1.4 | 0.5 | 1.2 | 0.45 | 1.0 | 0.4 | 14 |
| 23 | 1.4 | 0.5 | 1.2 | 0.45 | 1.0 | 0.4 | 14 |
| 24 | 1.4 | 0.5 | 1.2 | 0.45 | 1.0 | 0.4 | 14 |

### <<Cutting Test>>

### (Cutting Evaluation: Evaluation of Wear Resistance and Peeling Resistance Through Continuous Processing Test)

The cutting tools of the samples (Samples 1 to 24) manufactured as described above were used under the following cutting conditions to perform a cutting process and measure an area (in mm²) of the substrate exposed at the flank face every 1 minute of cutting time. A time when a cutting tool had such an exposed area exceeding 0.2 mm² was recorded the cutting tool's lifetime. A result thereof is shown in Tables 6-1 and 6-2. A cutting tool allowing a longer cutting time can be evaluated as a cutting tool with a flank face excellent in wear resistance. Furthermore, a cutting tool allowing a longer cutting time can be evaluated as a cutting tool excellent in peeling resistance. This is because large peeling resistance prevents the titanium carbonitride layer from peeling off and suppresses wear of the flank face.

### Cutting Conditions for Continuous Processing

Workpiece: SCM440 (shape: round bar)
Cutting speed: 250 m/min
Feed rate: 0.2 mm/rev

### Cutting Depth: 2.0 mm

Coolant: present (wet type)

Tables 6-1 and 6-2 show that the cutting tools of samples 2-4, 7-9, 12-14, 17-19, and 21-24 (or those of the examples) attained a cutting time of 12 minutes or longer in the cutting evaluation and thus provided a satisfactory result. In contrast, the cutting tools of samples 1, 5, 6, 10, 11, 15, 16 and 20 (or those of the comparative examples) attained a cutting time less than 10 minutes in the cutting evaluation. From the above results, it has been found that the cutting tools of the examples are superior in wear resistance and peeling resistance to those of the comparative examples.

From the above results, it has been found that the cutting tools of the examples are superior in wear resistance and peeling resistance to those of the comparative examples.

Thus, while embodiments and examples of the present invention have been described, it is also initially planned to combine configurations of the embodiments and examples, as appropriate.

It should be understood that the embodiments and examples disclosed herein have been described for the purpose of illustration only and in a non-restrictive manner in any respect. The scope of the present invention is defined by the terms of the claims, rather than the embodiments and examples described above, and is intended to include any modifications within the meaning and scope equivalent to the terms of the claims.

### REFERENCE SIGNS LIST

1 rake face, 2 flank face, 3 cutting edge ridge portion, 10 substrate, 20 alumina layer, 21 intermediate layer, 22 titanium carbonitride layer, 23 underlying layer, 24 surface layer, 30 CVD apparatus, 31 substrate setting jig, 32 reaction chamber, 33 temperature controller, 34 gas introduction port, 35 gas introduction pipe, 36 jetting hole, 40 coating, 50 cutting tool, A point A, B point B, C point C, I interface I, J interface J

1. A cutting tool comprising a substrate and a coating provided on the substrate,
the coating including
an alumina layer provided on the substrate,
an intermediate layer provided directly on the alumina layer, and
a titanium carbonitride layer provided directly on the intermediate layer,
the intermediate layer being made of titanium oxycarbonitride,
the titanium carbonitride layer being made of a compound represented by TiₓC_{y}N_{(1-y)},
at a point A 0.2 μm away from an interface I between the intermediate layer and the titanium carbonitride layer in a depthwise direction toward the titanium carbonitride layer,
the titanium carbonitride layer having an atomic ratio x_{A} of 1.3 or more and 1.6 or less for titanium,
the titanium carbonitride layer having an atomic ratio y_{A} of 0.4 or more and 0.6 or less for carbon,
at a point B 1.0 μm away from an interface J at the titanium carbonitride layer opposite to the interface I in the depthwise direction toward the titanium carbonitride layer,
the titanium carbonitride layer having an atomic ratio x_{B} of 0.8 or more and 1.2 or less for titanium,
the titanium carbonitride layer having an atomic ratio y_{B} of 0.3 or more and 0.5 or less for carbon,
at a point C that is a midpoint between the point A and the point B,
the titanium carbonitride layer having an atomic ratio x_{C} larger than the atomic ratio x_{B} and less than the atomic ratio x_{A} for titanium,
the titanium carbonitride layer having an atomic ratio y_{C} larger than the atomic ratio y_{B} and less than the atomic ratio y_{A} for carbon,
the intermediate layer having a thickness of 0.5 μm or more and 1.5 μm or less,
the titanium carbonitride layer having a thickness of 1.5 μm or more and 3.5 μm or less.

2. The cutting tool according to claim 1, wherein the alumina layer has a thickness of 2 μm or more and 20 μm or less.

3. The cutting tool according to claim 1, wherein at the point A,
the titanium carbonitride layer has an atomic ratio x_{A} of 1.4 or more and 1.5 or less for titanium, and
the titanium carbonitride layer has an atomic ratio y_{A} of 0.45 or more and 0.55 or less for carbon.

4. The cutting tool according to claim 1, wherein at the point B,
the titanium carbonitride layer has an atomic ratio x_{B} of 0.8 or more and 1.1 or less for titanium, and
the titanium carbonitride layer has an atomic ratio y_{B} of 0.3 or more and 0.45 or less for carbon.

5. The cutting tool according to claim 1, wherein the coating has a thickness of 6 μm or more and 30 μm or less.

6. The cutting tool according to claim 1, wherein the coating further includes an underlying layer provided between the substrate and the alumina layer.

7. The cutting tool according to claim 1, wherein the coating further includes a surface layer provided on the titanium carbonitride layer.
